(19) United States
(12) Patent Application Publication
(10) Pub. No.: US 2011/0224925 A1
(43) Pub. Date: Sep. 15, 2011

(54) Altimeter

(76) Inventor: Keisuke Tsubata, Chiba-shi (JP)

(21) Appl. No.: 12/932,489

(22) Filed: Feb. 24, 2011

(30) Foreign Application Priority Data
Mar. 15, 2010 (JP) 2010-058441

(51) Int. Cl. G06F 19/00

(52) U.S. Cl. 702/60; 702/138

(57) ABSTRACT

In an altimeter which makes use of power generated by a photoelectric conversion means as a drive power force, it is possible to prevent the altimeter from falling into a state where the altimeter cannot perform measurement of altitude due to large power consumption for measurement. A power generation part generates power for driving electrical constitutional elements corresponding to a received light quantity. A generated power measurement part measures generated power of the power generation part. An atmospheric pressure measurement part measures an atmospheric pressure. A control part controls an atmospheric pressure measurement interval used by the atmospheric pressure measurement part to an interval corresponding to the generated power quantity of the power generation part, calculates an altitude based on the atmospheric pressure measured by the atmospheric pressure measurement part, and displays the calculated altitude on a display part.

### BACKGROUND OF THE INVENTION

1. Field of the Invention

The present invention relates to an altimeter which measures an atmospheric pressure and obtains an altitude based on the measured pressure value, and more particularly to an altimeter which uses a photoelectric conversion means as a drive power source.

2. Background Art

Conventionally, an altimeter which measures an atmospheric pressure and obtains an altitude based on the measured pressure value has been used.

For example, JP-A-5-280977 (patent document 1) discloses the invention where the altitude measurement (atmospheric pressure measurement) is performed periodically for grasping a change of altitude in detail in mountain climbing or hiking.

JP-A-8-94382 (patent document 2) discloses the invention where the altitude measurement is periodically performed at optimum timing without being influenced by a moving speed of a moving body by automatically setting a time interval for measuring an altitude corresponding to the moving speed of the moving body.

JP-A-2002-48663 (patent document 3) discloses the invention where a time interval for measuring an altitude is shortened when it is determined that a moving body is moving.

On the other hand, a solar cell which is a photoelectric conversion means is used as a drive power source. To consider a case where the solar cell is used as a drive power source of the altimeters described in patent documents 1 to 3, when time interval for measuring an altitude is short in a state where a generated power quantity of the solar cell is small, generated power and power consumption become imbalanced thus giving rise to a possibility that the altitude measurement becomes impossible.

### SUMMARY OF THE INVENTION

It is an aspect of the present application to provide an altimeter which can perform the necessary altitude measurement while realizing power saving corresponding to a use environment of an altimeter.

According to the aspect of the present application, there is provided an altimeter which includes: an atmospheric pressure measurement means which measures an atmospheric pressure; and a control means which controls an atmospheric pressure measurement interval used by the atmospheric pressure measurement means to an interval corresponding to a use environment, and also calculates an altitude based on the atmospheric pressure measured by the atmospheric pressure measurement means.

For example, the altimeter includes: a photoelectric conversion means which generates power for driving an electric constitutional element corresponding a received light quantity; a generated power measurement means which measures a generated power quantity of the photoelectric conversion means, an atmospheric pressure measurement means which measures an atmospheric pressure; and a control means which sets an atmospheric pressure measurement interval used by the atmospheric pressure measurement means to an interval corresponding to a generated power quantity of the photoelectric conversion means, and also calculates an altitude based on the atmospheric pressure measured by the atmospheric pressure measurement means. By controlling the atmospheric pressure measurement interval used by the atmospheric pressure measurement means corresponding to the generated power quantity of the photoelectric conversion means which constitutes a use environment, the altimeter can perform the necessary altitude measurement while realizing the power saving.

According to the present application, the altimeter can perform the necessary altitude measurement while realizing the power saving corresponding to a use environment of the altimeter.

Further, with respect to the altimeter which makes use of power generated by the photoelectric conversion means as drive power, it is possible to prevent the altimeter from falling into a measurement inoperable state because of the large power consumption in altitude measurement.

### BRIEF DESCRIPTION OF THE DRAWINGS

FIG. 1 is a block diagram of an altimeter according to a first embodiment of the present invention;

FIG. 2 is a flowchart of processing performed by the altimeter according to the first embodiment of the present invention;

FIGS. 3A and 3b are explanatory views of a solar cell which is used in the embodiment of the present invention;

FIG. 4 is a block diagram of an altimeter according to a second embodiment of the present invention;

FIG. 5 is a flowchart of processing performed by the altimeter according to the second embodiment of the present invention;

FIG. 6 is a block diagram of an altimeter according to third and fourth embodiments of the present invention;

FIG. 7 is a flowchart of processing performed by the altimeter according to the third embodiment of the present invention;

FIG. 8 is a flowchart of processing performed by the altimeter according to the fourth embodiment of the present invention;

FIG. 9 is a block diagram of an altimeter according to a fifth embodiment of the present invention; and

FIG. 10 is a flowchart of processing performed by the altimeter according to the fifth embodiment of the present invention.

### DESCRIPTION OF THE PREFERRED EMBODIMENT

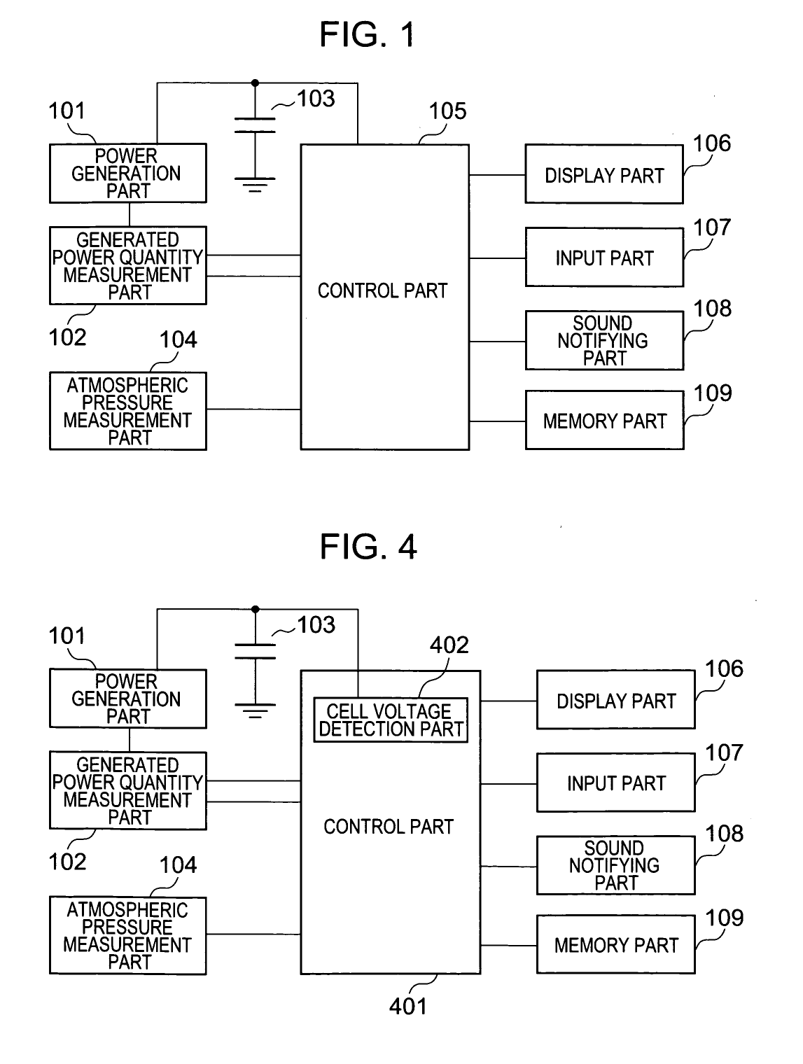

FIG. 1 is a block diagram of an altimeter according to a first embodiment of the present invention, and shows an example of a portable altimeter which a user uses while wearing on his body.

In FIG. 1, the altimeter includes: a power generation part 101 which generates power for driving electric constitutional elements of the altimeter corresponding to a received light quantity; a generated power quantity measurement part 102 which measures a generated power quantity of the power generation part 101; a secondary cell 103 which is charged with generated power of the power generation part 101 and functions as a power source for supplying drive power to the electric constitutional elements of the altimeter; an atmospheric pressure measurement part 104 which is constituted of an atmospheric pressure sensor and measures an atmospheric pressure (an altitude indirectly); a control part 105 which performs a control of a measurement interval used by the atmospheric pressure measurement part 104, the altitude calculation processing based on a measured atmospheric pressure and the like; a display part 106 which displays a calculated altitude and the like; an input part 107 which performs the instruction such as starting or stopping of the measurement of altitude and the like; a sound notifying part 108 which notifies predetermined matters with sounds; and a memory part 109 which stores a program which the control part 105 executes, measured atmospheric pressure data and the like. The control part 105 is constituted of a central processing unit (CPU), and performs the processing described later by executing the program stored in the memory part 109.

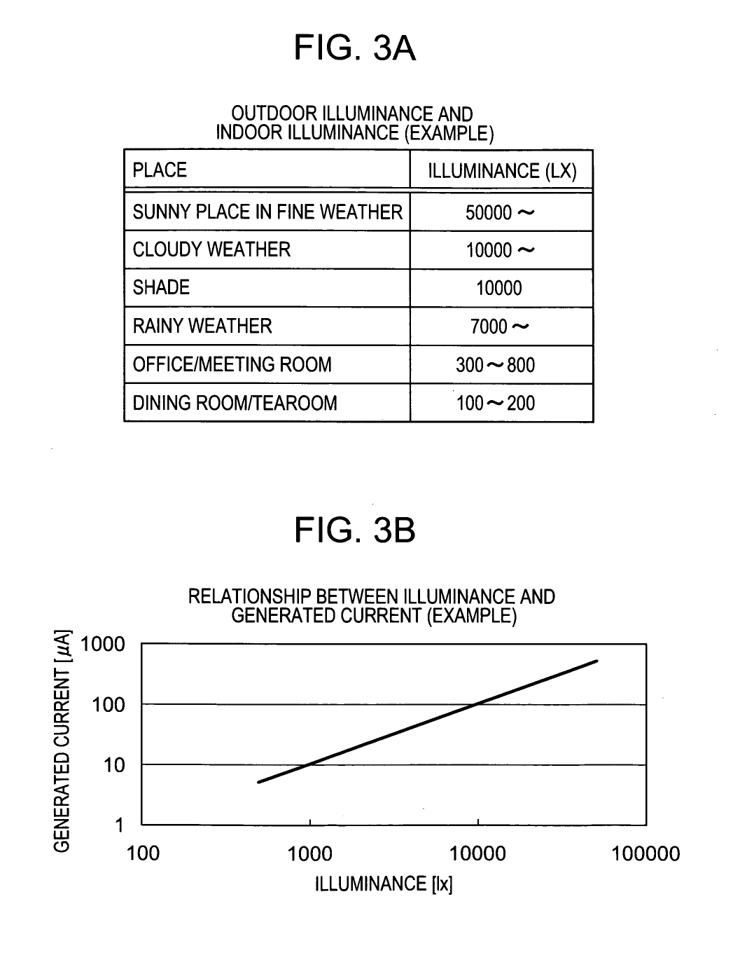

The power generation part 101 is an element which generates power by the photoelectric conversion. The power generation part 101 is constituted of a solar cell and has properties shown in FIGS. 3A and 3B. That is, FIG. 3A shows an example of illuminance obtained outdoors and indoors, and FIG. 3B shows an example of the relationship between the illuminance and a power generation current at the power generation part 101.

In FIG. 3A, “sunny place in fine weather”, “cloudy weather”, “shade” and “rainy weather” indicate respective outdoor illuminance corresponding to respective weathers, “office/meeting room”, and “dining room/tearoom” indicate respective indoor illuminance corresponding to respective rooms. As shown in FIG. 3A, irrelevant to the weather or the like, the indoor illuminance is 800 lx or less and outdoor illuminance is 7000 lx or more. Accordingly, by setting approximately 2000 lx, for example, as a threshold valve of illuminance for differentiating the outdoor and the indoor from each other, it is possible to determine that the measurement is performed indoors when the measured illuminance is less than the threshold value, and the measurement is performed outdoors when the measured illuminance is the threshold value or more.

Accordingly, in this case, as shown in FIG. 3B, by setting a power generation current of 20 μA at the power generation part 101 when the illuminance is 200 lx as a threshold value for differentiating the outdoor and the indoor from each other, the control part 105 can determine whether the altimeter is installed indoors or outdoors based on whether or not generated power quantity (power generation current in this case) of the power generation part 101 which is measured by the generated power quantity measurement part 102 is the threshold value or more. The threshold value can be suitably selected corresponding to use conditions or the like.

The power generation part 101 constitutes a photoelectric conversion means which generates power for driving the electric constitutional elements corresponding to a received light quantity. The generated power quantity measurement part 102 constitutes a generated power quantity measurement means which measures generated power quantity of the photoelectric conversion means. The atmospheric pressure measurement part 104 constitutes an atmospheric pressure measurement means which measures an atmospheric pressure. The control part 105 constitutes a control means. Respective circuit elements which constitute the altimeter, that is, the generated power quantity measurement part 102, the atmospheric pressure measurement part 104, the control part 105 and the like form the electric constitutional elements.

The control means can set an atmospheric pressure measurement interval used by the atmospheric pressure measurement means to an interval corresponding to a generated power quantity of the photoelectric conversion means, and can also calculate an altitude based on an atmospheric pressure measured by the atmospheric pressure measurement means.

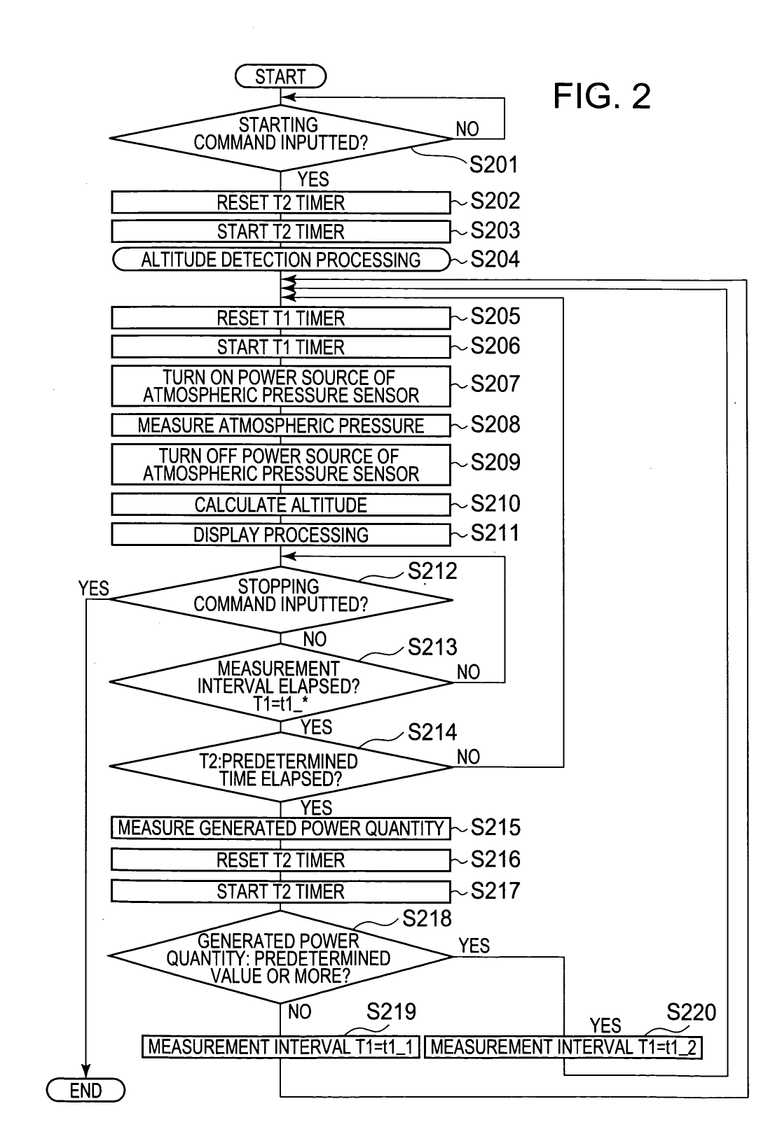

FIG. 2 is a flowchart showing processing performed by the altimeter according to the first embodiment of the present invention.

Hereinafter, the manner of operation of the altimeter according to the first embodiment of the present invention is explained in conjunction with FIG. 1 to FIG. 3.

A user uses the altimeter while wearing the altimeter on his body such as his wrist or by carrying the altimeter with him by putting the altimeter in a bag or the like. To start the measurement of altitude, the user inputs an altitude measurement starting command into the control part 105 by manipulating the input part 107.

When the control part 105 determines that the altitude measurement starting command is inputted to the control part 105 from the input part 107 (step S201), the control part 105 resets a T2 timer (second time measurement means) which measures whether or not a predetermined second time T2 is elapsed (step S202), starts the T2 timer (step S203) and, thereafter, advances the processing to the following altitude detection processing (step S204). Here, the second time T2 is a time interval for confirming the illuminance.

In the altitude detection processing, the control part 105 firstly resets a T1 timer (first time measurement means) which measures a predetermined first time T1 (step S205), starts the T1 timer (step S206) and, thereafter, turns on a power source of the atmospheric pressure measurement part 104 which is constituted of an atmospheric pressure sensor thus starting the measurement of an atmospheric pressure (step S207). Here, the first time T1 is a measurement interval during which an atmospheric pressure (in other words, an altitude) is measured.

Next, the control part 105 allows the atmospheric pressure measurement part 104 to perform the measurement of an atmospheric pressure (step S208) and, thereafter, finishes the atmospheric pressure measuring operation by turning off the power source of the atmospheric pressure measurement part 104 (step S209). Next, the control part 105 calculates an altitude based on atmospheric pressure data measured by the atmospheric pressure measurement part 104 (step S210), and displays a calculated altitude value on the display part 106 (step S211). Next, when the control part 105 determines that an altitude measurement stopping command is inputted to the control part 105 from the input part 107, the control part 105 finishes the altitude measuring operation (step S212).

When the control part 105 determines that the altitude measurement stopping command is not inputted to the control part 105 from the input part 107 in processing step S212, the control part 105 determines whether or not the first time T1 (atmospheric pressure measurement interval) is elapsed (step S213). When the control part 105 determines that the first time T1 is not elapsed in step S213, the control part 105 returns the processing to processing step S212. When the control part 105 determines that the first time T1 is elapsed in step S213, the control part 105 determines whether or not the second time T2 is elapsed (step S214).

When the control part 105 determines that the second time T2 is not elapsed in step S214, the control part 105 returns the processing to processing step S205. When the control part 105 determines that the second time T2 is elapsed in step S214, the control part 105 allows the generated power quantity measurement part 102 to measure a generated power quantity of the power generation part 101 thus obtaining data on the generated power quantity (step S215).

Next, the control part 105 resets the T2 timer (step S216), starts the T2 timer (step S217) and, thereafter, determines whether or not the generated power quantity of the power generation part 101 is the predetermined threshold value or more (step S218). The threshold value is, as explained in conjunction with FIGS. 3A and 3B, the reference value for determining whether the altimeter is installed indoors or outdoors. For example, the threshold value is the power generation current of 20 μA at the power generation part 101.

When the generated power quantity of the power generation part 101 is less than the threshold value in step S218, the control part 105 determines that the altimeter is installed indoors so that a large generated power quantity cannot be obtained, and the control part 105 sets the first time T1 to a first atmospheric pressure measurement interval t1_1 which is a large interval, and returns the processing to processing step S205 (step S219). On the other hand, when the generated power quantity of the power generation part 101 is the threshold value or more in step S218, the control part 105 determines that the altimeter is installed outdoors so that a large generated power quantity can be obtained, and the control part 105 sets the first time T1 to a second atmospheric pressure measurement interval t1_2 which is smaller than the first atmospheric pressure measurement interval t1_1, and returns the processing to processing step s205 (step S220).

As described above, the altimeter according to the first embodiment of the present invention is characterized in that the altimeter includes the atmospheric pressure measurement part 104 which measures an atmospheric pressure, and the control part 105 which sets an atmospheric pressure measurement interval used by the atmospheric pressure measurement part 104 to an interval corresponding to the use environment of the altimeter (the generated power quantity of the power generation part 101 in the first embodiment) and also calculates an altitude based on the atmospheric pressure measured by the atmospheric pressure measurement part 104.

Due to such a constitution, the altimeter can perform the necessary altitude measurement while realizing power saving corresponding to a use environment of the altimeter.

Further, the altimeter according to the first embodiment of the present invention is characterized in that the altimeter includes: the power generation part 101 which generates power for driving the electric constitutional elements of the altimeter corresponding to a received light quantity; the generated power quantity measurement part 102 which measures a generated power quantity of the power generation part 101; the atmospheric pressure measurement part 104 which measures an atmospheric pressure; and the control part 105 which sets an atmospheric pressure measurement interval used by the atmospheric pressure measurement part 104 to an interval corresponding to the generated power quantity of the power generation part 101 and also calculates an altitude based on an atmospheric pressure measured by the atmospheric pressure measurement part 104. The calculated altitude is displayed on the display part 106.

Accordingly, when the altimeter is installed indoors, an altitude measurement interval is prolonged so that the altitude measurement operation can be performed with low power consumption. On the other hand, when the altimeter is installed outdoors, the altitude measurement interval is shortened so that the altitude measurement operation can be performed with high accuracy. Therefore, it is possible to acquire the power balance between the generated power quantity of the power generation part 101 and the power consumption of the altimeter.

Further, when the altimeter is installed outdoors, the user is in a moving state so that a change of altitude is large in many cases, while when the altimeter is installed indoors, the user is not in a very moving state so that the change of altitude is small in many cases. Accordingly, it is possible to perform the altitude measurement with high accuracy while acquiring the power balance by taking the generated power quantity of the power generation part 101 into consideration. Further, it is possible to prevent the occurrence of a case where the altitude cannot be measured due to the reduction of a power storage quantity of the secondary cell 103.

Further, the measurement is not always performed at a fine interval but the measurement interval is changed such that the measurement is performed at the fine interval only when such measurement is necessary corresponding to the use environment and hence, a capacity of the memory part 109 which stores the measurement data can be made small.

FIG. 4 is a block diagram of an altimeter according to a second embodiment of the present invention, and shows an example of a portable altimeter which is used by a user in the substantially same manner as the altimeter according to the first embodiment. In FIG. 4, parts identical with the parts shown in FIG. 1 are given same symbols.

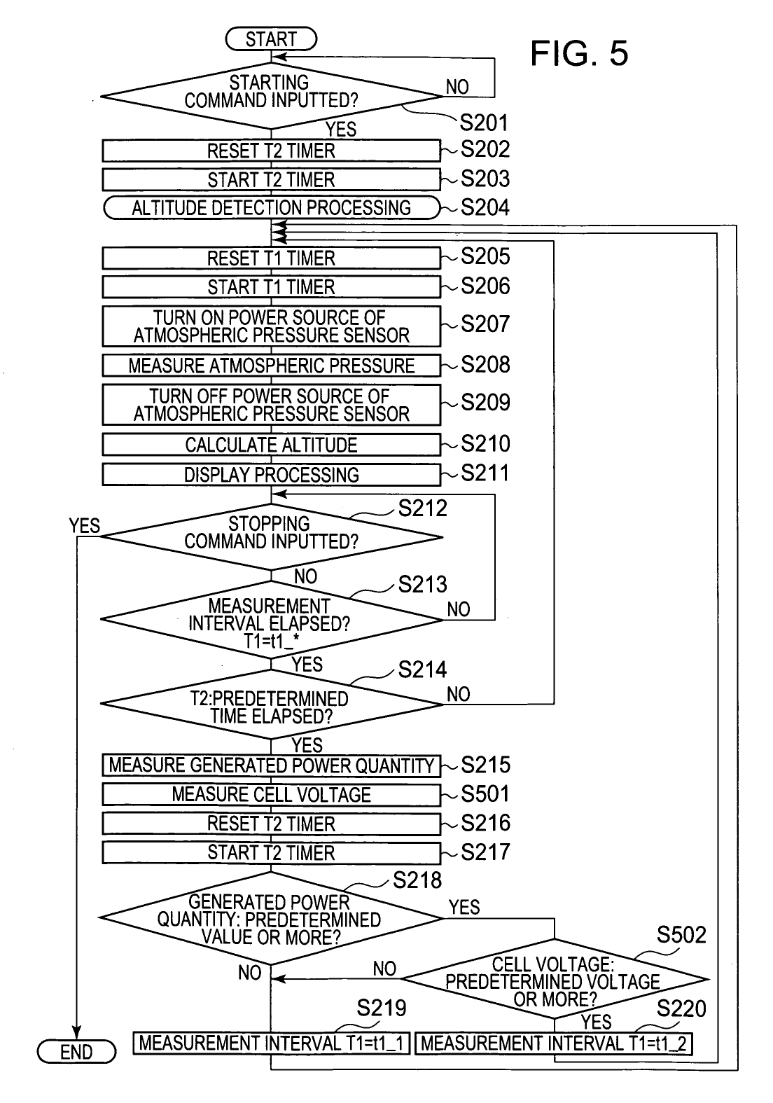

In FIG. 4, a control part 401 may be constituted of a CPU, and performs the processing shown in FIG. 5 described later by executing a program stored in the memory part 109. Further, the control part 401 includes a cell voltage detection part 402 which measures a terminal voltage of a secondary cell 103. Other constitutions of this embodiment are equal to the corresponding constitutions shown in FIG. 1. Here, the control part 401 constitutes a control means, and the cell voltage detection part 402 constitutes a voltage measurement means.

FIG. 5 is a flowchart showing processing performed by the altimeter according to the second embodiment of the present invention. In FIG. 5, steps which perform the same processing as steps shown in FIG. 2 are given same symbols.

In the first embodiment, the altimeter controls the altitude measurement interval by taking the generated power quantity of the power generation part 101 into consideration as the use environment of the altimeter. In the second embodiment, the altimeter controls the altitude measurement interval by taking both a generated power quantity of a power generation part 101 and a voltage of a secondary cell 103 into consideration as the use environment of the altimeter.

Hereinafter, the manner of operation of the altimeter of the second embodiment is explained in conjunction with FIG. 4 and FIG. 5 with respect to steps which differ from the steps of the first embodiment.

The control part 401 obtains data on generated power quantity by measuring generated power quantity of a power generation part 101 using a generated power measurement part 102 in processing step S215 shown in FIG. 5 and, thereafter, obtains voltage value data of a secondary cell 103 by measuring the voltage of the secondary cell 103 using the cell voltage detection part 402 (step S501).

When the generated power quantity of the power generation part 101 is less than the above-mentioned threshold value in processing step S218, in the same manner as the first embodiment, the control part 401 determines that the altimeter is installed indoors so that a large generated power quantity cannot be obtained, and the control part 401 sets a first time T1 (atmospheric pressure measurement interval) to a first atmospheric pressure measurement interval t1_1 which is a long interval, and returns the processing to processing step S205 (step S219).

When the generated power quantity of the power generation part 101 is the above-mentioned threshold value or more in processing step S218 and when a voltage of the secondary cell 103 measured by the cell voltage detection part 402 is less than a predetermined voltage (step S502), the control part 401 determines that a power storage quantity of the secondary cell 103 is small although the altimeter is installed outdoors so that a large generated power quantity can be obtained, and the control part 401 sets the first time T1 to the first atmospheric pressure measurement interval t1_1 which is a long interval, and returns the processing to processing step S205 (step S219).

When the control part 401 determines that the cell voltage of the secondary cell 103 is the predetermined voltage or more in step S502, the control part 401 determines that the altimeter is installed outdoors so that a large generated power can be obtained and a power storage quantity of the secondary cell 103 is also sufficiently large, and the control part 401 sets the first time T1 to a second atmospheric pressure measurement interval t1_2 which is shorter than the first atmospheric pressure measurement interval t1_1, and returns the processing to processing step S205 (step S220).

In this manner, the altimeter according to the second embodiment of the present invention is characterized in that the altimeter includes the atmospheric pressure measurement part 104 which measures an atmospheric pressure, and the control part 105 which sets an atmospheric pressure measurement interval used by the atmospheric pressure measurement part 104 to an interval corresponding to the use environment of the altimeter (the generated power quantity of the power generation part 101 and the voltage of the secondary cell 103 in the second embodiment) and also calculates an altitude based on the atmospheric pressure measured by the atmospheric pressure measurement part 104.

Due to such a constitution, in the same manner as the first embodiment, the altimeter can perform the necessary altitude measurement while realizing power saving corresponding to a use environment of an altimeter.

Further, the altimeter according to the second embodiment particularly includes the secondary cell 103 which stores generated power of the power generation part 101 and supplies drive power to the respective electric constitutional elements which constitute the altimeter; and the cell voltage detection part 402 which measures a voltage of the secondary cell 103, wherein the control part 401 controls the atmospheric pressure measurement part 104 such that the atmospheric pressure measurement interval becomes shorter when the generated power quantity of the power generation part 101 is a predetermined value or more and the voltage of the secondary cell 103 is a predetermined value or more.

Due to such a constitution, when the altimeter is installed indoors or when the power storage quantity of the secondary cell 103 is less than the predetermined quantity although the altimeter is installed outdoors, the altitude measurement interval is prolonged so that the altitude measurement operation is performed with low power consumption, while when the altimeter is installed outdoors and the power storage quantity of the secondary cell 103 is the predetermined quantity or more, the altitude measurement interval is shortened so that the altitude measurement operation is performed with high accuracy. Accordingly, it is possible to acquire a power balance between the generated power quantity of the power generation part 101 and the power consumption of the altimeter by also taking the power storage quantity of the secondary cell 103 into consideration.

Accordingly, it is possible to perform the altitude measurement with high accuracy while acquiring the power balance by taking the generated power quantity of the power generation part 101 and the power storage quantity of the secondary cell 103 into consideration. Further, it is possible to prevent the occurrence of a case where the altitude cannot be measured due to the reduction of a power storage quantity of the secondary cell 103.

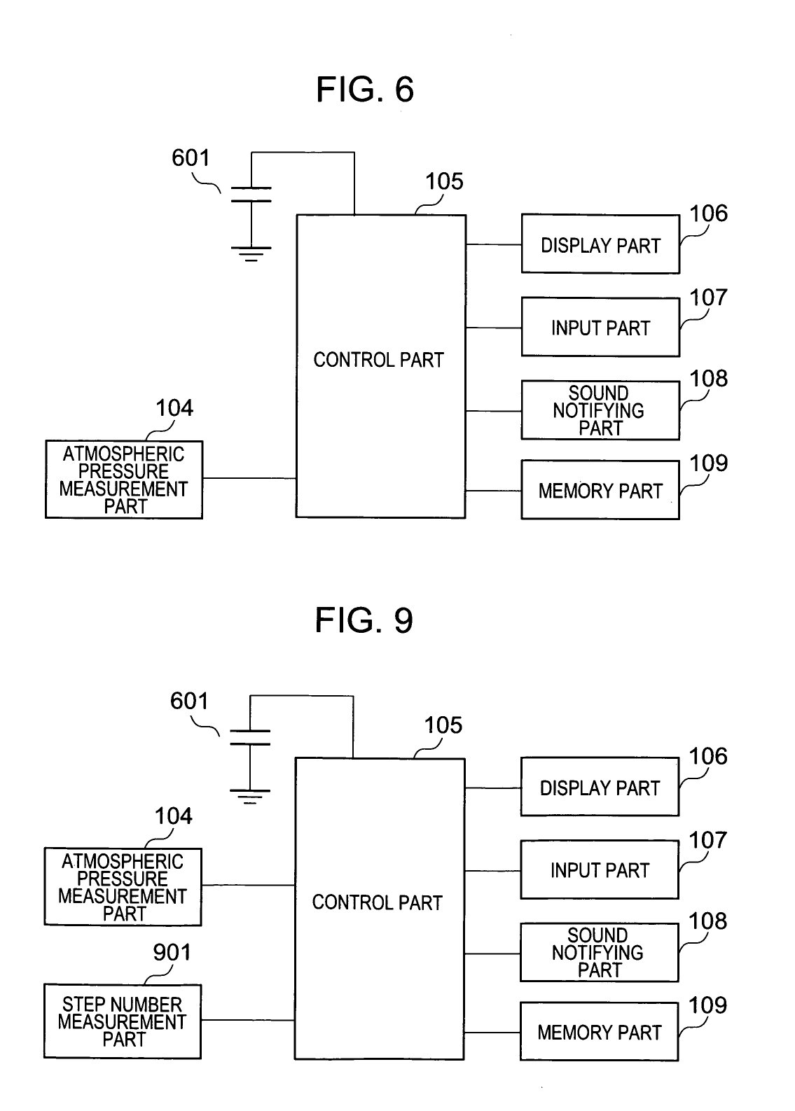

FIG. 6 is a block diagram of an altimeter according to the third embodiment of the present invention, and shows an example of a portable altimeter which a user uses while carrying with him in the same manner as the first embodiment. Parts identical with the parts shown in FIG. 1 are given the same symbols.

As shown in FIG. 6, the altimeter shown in FIG. 1 according to the third embodiment differs from the altimeter according to the first embodiment with respect to a point that the altimeter according to the third embodiment includes neither the power generation part 101 nor the generated power quantity measurement part 102, and includes a primary cell 601 which constitutes a power source for supplying drive power to respective electric constitutional elements of the altimeter in place of the secondary cell 103. A secondary cell may be used in place of the primary cell 601. Other constitutions including the constitution where a control part 105 forms a control means are equal to the corresponding constitutions of the first embodiment shown in FIG. 1.

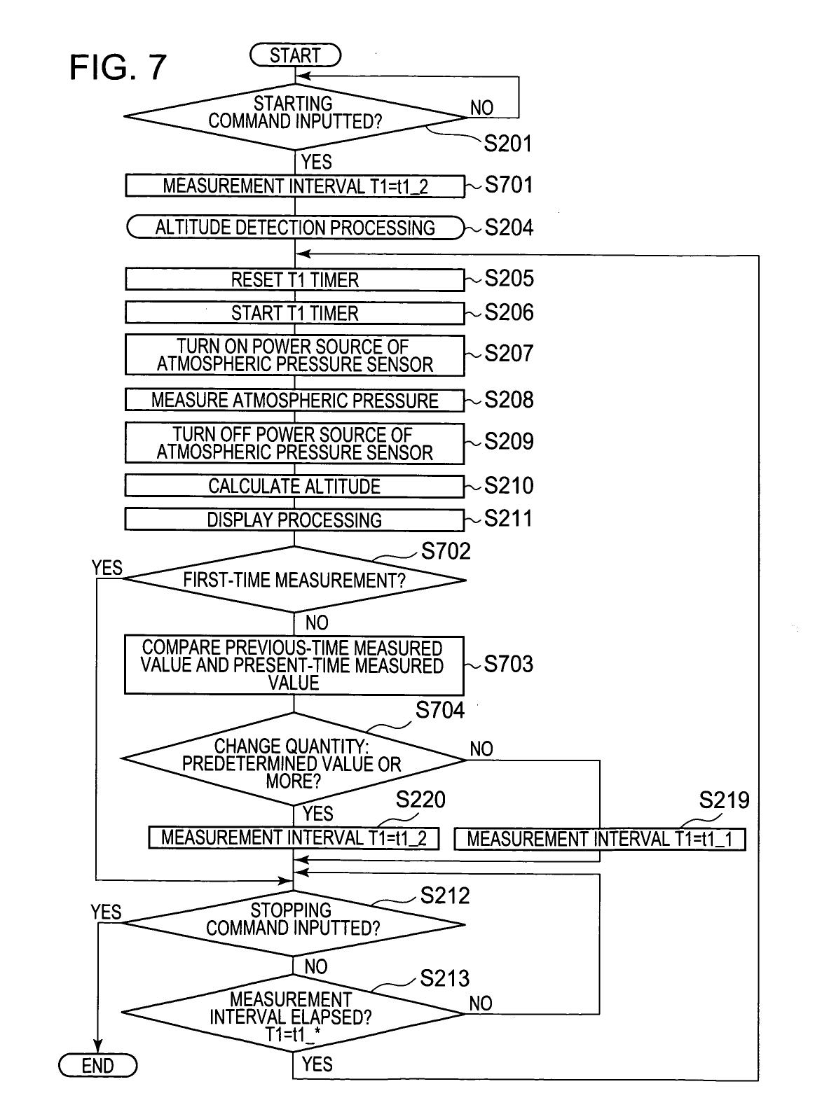

FIG. 7 is a flowchart showing processing performed by the altimeter according to the third embodiment of the present invention. In FIG. 7, steps which perform the same processing as steps shown in FIG. 2 are given same symbols.

The manner of operation of the altimeter according to the third embodiment of the present invention is explained hereinafter in conjunction with FIG. 6 and FIG. 7.

A user uses the altimeter while carrying the altimeter with him by wearing the altimeter on his body such as his wrist or by putting the altimeter in a bag or the like. To start the measurement of altitude, the user inputs an altitude measurement starting command into the control part 105 by manipulating the input part 107.

When the control part 105 determines that the altitude measurement starting command is inputted to the control part 105 from the input part 107 (step S201), the control part 105 sets a measurement interval T1 of an atmospheric pressure (that is, altitude) to a second atmospheric pressure measurement interval t1_2 which is an initial state (step S701) and, thereafter, advances the processing to the following altitude detection processing (step S204).

In the altitude detection processing, the control part 105 firstly resets a T1 timer (first time measurement means) which measures the first time T1 (step S205), starts the T1 timer (step S206) and, thereafter, turns on a power source of the atmospheric pressure measurement part 104 which is constituted of an atmospheric pressure sensor thus starting the measurement of an atmospheric pressure (step S207).

Next, the control part 15 allows the atmospheric pressure measurement part 104 to perform the measurement of an atmospheric pressure (step S208) and, thereafter, finishes the atmospheric pressure measuring operation by turning off the power source of the atmospheric pressure measurement part 104 (step S209). Next, the control part 105 calculates an altitude based on atmospheric pressure data measured by the atmospheric pressure measurement part 104 (step S210), and displays a calculated altitude value on the display part 106 (step S211). The control part 105 sequentially stores atmospheric pressure data which is measured by the atmospheric pressure measurement part 104 in processing step S208 and altitude data calculated in processing step S210 in a memory part 109.

When the control part 105 determines that the present-time altitude measurement is not the first-time altitude measurement (step S702), the control part 105 compares a previous-time altitude measurement value stored in the memory part 109 and a present-time altitude measurement value with each other (step S703), sets the measurement interval T1 to the second atmospheric pressure measurement interval t1_2 when a change quantity per unit time (a differential value of an atmospheric pressure measurement value or an altitude measurement value, the difference between the previous-time altitude measurement value and the present-time altitude measurement value in this embodiment) is a predetermined value or more (since the measurement interval T1 is set to the second atmospheric pressure measurement interval t1_2 in processing step S701 in the third embodiment of the present invention, no processing is performed in this processing) (steps S704, S220). When the change quantity per unit time is less than the predetermined value, the control part 105 sets the measurement interval T1 to the first atmospheric pressure measurement interval t1_1 which is longer than the second atmospheric pressure measurement interval t1_2 (step S219).

Accordingly, when the change quantity of an atmospheric pressure (or altitude) per unit time is the predetermined value or more, the control part 105 controls the atmospheric pressure measurement part 104 such that the measurement interval T1 becomes shorter than the measurement interval T1 when the change quantity of the atmospheric pressure (or altitude) per unit time is less than the predetermined value. Further, when the change quantity of the atmospheric pressure (or altitude) per unit time is less than the predetermined value, the control part 105 controls the atmospheric pressure measurement part 104 such that the measurement interval T1 becomes longer than the measurement interval T1 when the change quantity of the atmospheric pressure (or altitude) per unit time is the predetermined value or more.

Next, when the control part 105 determines that an altitude measurement stopping command is inputted to the control part 105 from the input part 107, the control part 105 finishes the altitude measuring operation (step S212).

When the control part 105 determines that the altitude measurement stopping command is not inputted to the control part 105 from the input part 107 in processing step S212, the control part 105 determines whether or not the measurement time T1 is elapsed (step S213). When the control part 105 determines that the first time T1 is not elapsed in the processing step S213, the control part 105 returns the processing to the processing step S212, and when the control part 105 determines that the first time T1 is elapsed, the control part 105 returns the processing to the processing step S205, and repeats the above-mentioned processing at a predetermined cycle.

When the control part 105 determines that the altitude measurement is the first-time altitude measurement in processing step S702, the control part 105 advances the processing to processing step S212, and determines whether or not an altitude measurement stopping command is inputted to the control part 105 from an input part 107.

Although the control part 105 performs the control such that the measurement interval is changed based on whether or not the change in altitude per unit time is the predetermined value or more in the third embodiment of the present invention, the control part 105 may perform a control such that the measurement interval is changed based on whether or not a change in atmospheric pressure per unit time is the predetermined value or more.

In this manner, the altimeter according to the third embodiment of the present invention, and particularly, the control part 105 of the altimeter is configured to control the atmospheric pressure measurement part 104 such that the atmospheric pressure measurement interval becomes shorter when a change quantity per unit time of the atmospheric pressure which the atmospheric pressure measurement part 104 measures or of an altitude calculated based on the atmospheric pressure measured by the atmospheric pressure measurement part 104 is a predetermined value or more compared to a case where the change quantity per unit time of the atmospheric pressure which the atmospheric pressure measurement part 104 measures or of the altitude calculated based on the atmospheric pressure measured by the atmospheric pressure measurement part 104 is less than the predetermined value.

Further, the altimeter according to the third embodiment of the present invention, and particularly, the control part 105 of the altimeter is configured to control the atmospheric pressure measurement part 104 such that the atmospheric pressure measurement interval becomes longer when a change quantity per unit time of the atmospheric pressure which the atmospheric pressure measurement part 104 measures or of an altitude calculated based on the atmospheric pressure measured by the atmospheric pressure measurement part 104 is less than a predetermined value compared to a case where the change quantity per unit time of the atmospheric pressure which the atmospheric pressure measurement part 104 measures or of the altitude calculated based on the atmospheric pressure measured by the atmospheric pressure measurement part 104 is the predetermined value or more.

Due to such a constitution, the altimeter of the third embodiment can perform necessary altitude measurement while realizing power saving corresponding to a use environment of the altimeter. Further, the fine measurement is unnecessary when a change quantity of atmospheric pressure or altitude per unit time is small in many cases and hence, it is possible to realize power saving without inducing the deterioration of the accuracy of measurement which may be caused by prolongation of measurement interval. On the other hand, when a change quantity of atmospheric pressure or altitude per unit time is large, the fine measurement of the change of atmospheric pressure or the like is necessary in many cases. In such a case, it is possible to maintain the high measurement accuracy by shortening the measurement interval.

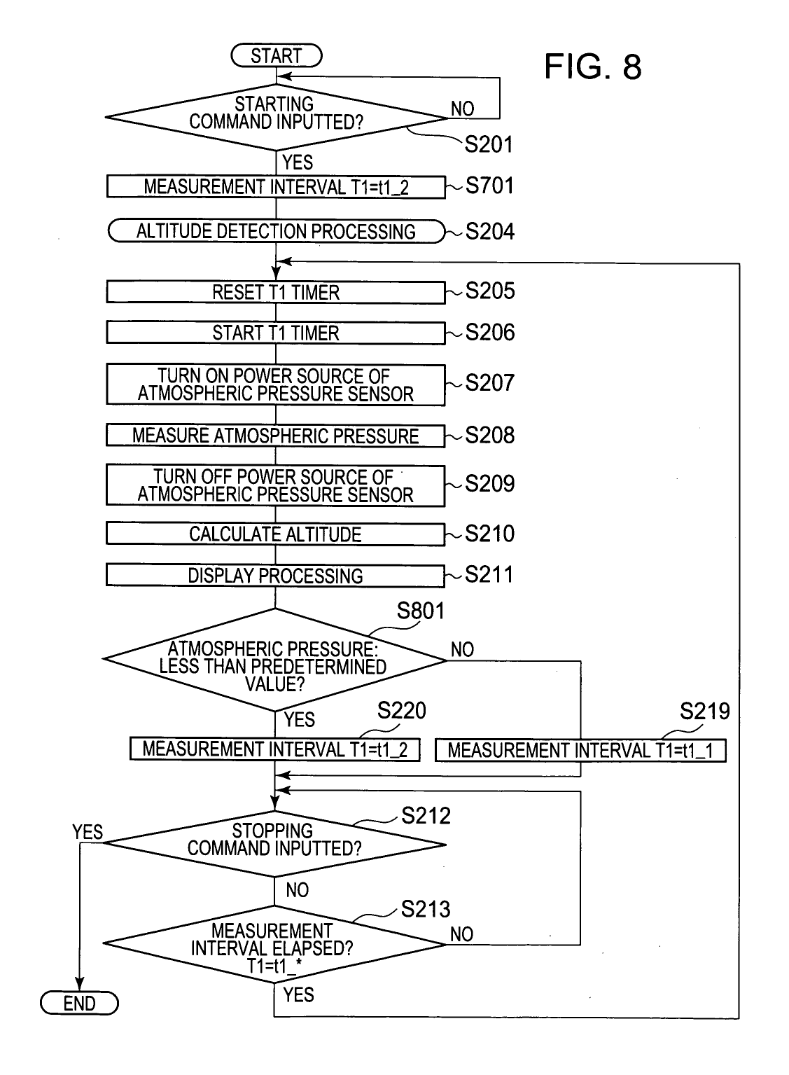

FIG. 8 is a flowchart showing processing performed by the altimeter according to the fourth embodiment of the present invention. In FIG. 8, steps which perform the same processing as steps shown in FIG. 7 are given same symbols. The black diagram of altimeter according to the fourth embodiment is equal to that of FIG. 6.

Hereinafter, the manner of operation of the altimeter of the fourth embodiment of the present invention is explained in conjunction with FIG. 6 and FIG. 8 with respect to steps which differ from the steps of the third embodiment.

The control part 105 allows the atmospheric pressure measurement part 104 to perform the measurement of atmospheric pressure at a measurement interval T1 (=t1_2) set in processing step S701 (step S208) and, thereafter, the control part 105 finishes the atmospheric pressure measuring operation by turning off a power source of the atmospheric pressure measurement part 104 (step S209). The control part 105 calculates an altitude using atmospheric pressure data obtained as the result of measurement by the atmospheric pressure measurement part 104 (step S210), and displays a calculated altitude value on a display part 106 (step S211). The control part 105 sequentially stores the atmospheric pressure data and data on altitude calculated in processing step 210 in a memory part 109.

Next, the control part 105 controls a measurement interval based on whether or not the measured atmospheric pressure (in other words, altitude) is a predetermined value or more (steps S801, S219, S220). That is, the control part 105 sets the measurement interval T1 to the second atmospheric pressure measurement interval t1_2 when the measured atmospheric pressure is less than a predetermined value (since the measurement interval T1 is set to the second atmospheric pressure measurement interval t1_2 in processing step S701 in the fourth embodiment of the present invention, no processing is performed in this processing) (step S220), and the control part 105 sets the measurement interval T1 to the first atmospheric pressure measurement interval t1_1 which is longer than the second atmospheric pressure measurement interval t1_2 when the measured atmospheric pressure is a predetermined value or more (step S219).

Accordingly, the control part 105 controls the atmospheric pressure measurement part 104 such that the measurement interval T1 becomes shorter when the atmospheric pressure (or altitude) is less than the predetermined value compared to a case where the atmospheric pressure (or altitude) is the predetermined value or more. Further, the control part 105 controls the atmospheric pressure measurement part 104 such that the measurement interval T1 becomes longer when the atmospheric pressure (or altitude) is the predetermined value or more compared to a case where the atmospheric pressure (or altitude) is less than the predetermined value.

In this manner, the altimeter according to the fourth embodiment of the present invention, and particularly, the control part 105 of the altimeter is configured to control the atmospheric pressure measurement part 104 such that the atmospheric pressure measurement interval becomes shorter when the atmospheric pressure measured by the atmospheric pressure measurement part 104 is less than the predetermined value compared to a case where the atmospheric pressure measured by the atmospheric pressure measurement part 104 is the predetermined value or more. As such cases where the atmospheric pressure is low, mountain climbing, the approach of the low atmospheric pressure and the like are considered, and these cases require the accurate measurement of the atmospheric pressure or the altitude. Accordingly, in such cases, the altimeter of this embodiment can perform the measurement of the atmospheric pressure or the altitude with high accuracy by shortening the measurement interval.

Further, the altimeter according to the fourth embodiment of the present invention, and particularly, the control part 105 of the altimeter is configured to control the atmospheric pressure measurement part 104 such that the atmospheric pressure measurement interval becomes longer when the atmospheric pressure measured by the atmospheric pressure measurement part 104 is the predetermined value or more compared to a case where the atmospheric pressure measured by the atmospheric pressure measurement part 104 is less than the predetermined value. When the atmospheric pressure is high, it is not particularly necessary to measure the atmospheric pressure or the altitude accurately in many cases. In such cases, it is possible to realize power saving by prolonging the measurement interval.

Due to such a constitution, the altimeter of the fourth embodiment can perform necessary altitude measurement while realizing power saving corresponding to a use environment of the altimeter that the altitude is high or low.

FIG. 9 is a block diagram of an altimeter according to a fifth embodiment of the present invention, and shows an example of a portable altimeter which a user uses while carrying with him in the same manner as the first embodiment. The altimeter according to the fifth embodiment of the present invention possesses a pedometer function for counting the number of steps by detecting walking of a user. In FIG. 9, parts identical with the parts shown in FIG. 1 are given the same symbols.

In FIG. 9, the altimeter according to the fifth embodiment of the present invention includes neither the power generation part 101 nor the generated power quantity measurement part 102, and includes a primary cell 601 which constitutes a power source for supplying drive power to respective electric constitutional elements of an altimeter in place of the secondary cell 103. Further, the altimeter according to the fifth embodiment includes a step number measurement part 901 which measures the number of steps by detecting each step of a user. The altimeter may use a secondary cell in place of the primary cell 601. The step number measurement part 901 constitutes a step detection means for detecting steps of the user. Other constitutions including the constitution where a control part 105 forms a control means are equal to the corresponding constitution of the first embodiment shown in FIG. 1.

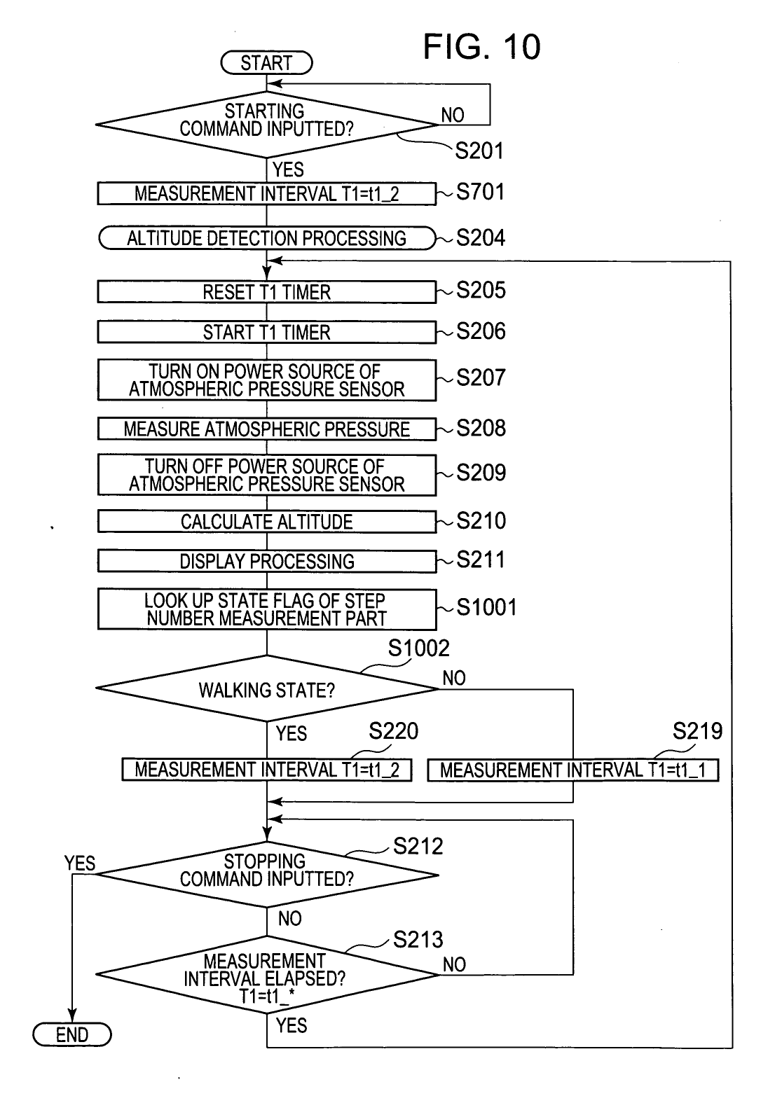

FIG. 10 is a flowchart showing processing performed by the altimeter according to the fifth embodiment of the present invention. In FIG. 10, steps which perform the same processing as steps shown in FIG. 8 are given same symbols.

The manner of operation of the altimeter according to the fifth embodiment of the present invention is explained hereinafter in conjunction with FIG. 9 and FIG. 10.

A user uses the altimeter while carrying the altimeter with him by wearing the altimeter on his body such as his wrist or by putting the altimeter in a bag or the like. To start the measurement of altitude and the step number measurement, the user inputs an altitude measurement starting command and a step number measurement starting command into the control part 105 by manipulating the input part 107.

When the control part 105 determines that the altitude measurement starting command is inputted to the control part 105 from the input part 107 (step S201), the control part 105 sets a measurement interval T1 to a first atmospheric pressure measurement interval t1_2 which is an initial state (step S701) and, thereafter, advances the processing to the following altitude detection processing (step S204).

On the other hand, when the step number measurement part 901 detects walking of the user, the step number measurement part 901 sets a state flag indicative of whether or not a user is in the midst of walking to a walking state or outputs a step number signal to the control part 105 each time walking is detected. The control part 105 calculates a cumulative number of steps of the user by counting the step number signals, and displays the number of steps on a display part 106. The control part 105 always stores the calculated number of steps in the memory part 109.

In the altitude detection processing, the control part 105 firstly resets a T1 timer (first time measurement means) which measures a predetermined measurement time T1 (step S205), starts the T1 timer (step S206) and, thereafter, turns on a power source of the atmospheric pressure measurement part 104 which is constituted of an atmospheric pressure sensor thus starting the measurement of an atmospheric pressure (step S207).

Next, the control part 105 allows the atmospheric pressure measurement part 104 to perform the measurement of an atmospheric pressure (step S208) and, thereafter, finishes the atmospheric pressure measuring operation by turning off the power source of the atmospheric pressure measurement part 104 (step S209). Next, the control part 105 calculates an altitude based on atmospheric pressure data measured by the atmospheric pressure measurement part 104 (step S210), and displays a calculated altitude value on the display part 106 (step S211). The control part 105 sequentially stores data on altitude which is calculated in processing step S210 in a memory part 109.

Next, the control part 105 looks up the state flag of the step number measurement part 901 (step S1001), and determines whether or not the user is walking (step S1002).

When the control part 105 determines that the state flag is set to a walking state in processing step S1002, the control part 105 determines that the user is in the midst of walking and sets the measurement interval T1 of atmospheric pressure to a second atmospheric pressure measurement interval t1_2 (since the measurement interval T1 is set to the second atmospheric pressure measurement interval t1_2 in processing step S701 in the fifth embodiment of the present invention, no processing is performed in this processing) (step S220). When the control part 105 determines that the state flag is set to a stop state in processing step S1002, the control part 105 determines that the user stops walking and sets the measurement interval T1 of atmospheric pressure to a first atmospheric pressure measurement interval t1_1 which is longer than the second atmospheric pressure measurement interval t1_2 (step S219).

In this manner, the control part 105 is configured to control the atmospheric pressure measurement part 104 such that the atmospheric pressure measurement interval T1 becomes shorter when the step number measurement part 901 detects that the user is walking compared to a case where the step number measurement part 901 detects that the user is not walking. On the other hand, the control part 105 is configured to control the atmospheric pressure measurement part 104 such that the atmospheric pressure measurement interval T1 becomes longer when the step number measurement part 901 detects that the user is not walking compared to a case where the step number measurement part 901 detects that the user is walking.

Next, when the control part 105 determines that an altitude measurement stopping command is inputted to the control part 105 from the input part 107, the control part 105 finishes the altitude measuring operation (step S212).

When the control part 105 determines that the altitude measurement stopping command is not inputted to the control part 105 from the input part 107 in processing step S212, the control part 105 determines whether or not the measurement interval T1 is elapsed (step S213). When the control part 105 determines that the measurement interval T1 is not elapsed in processing step S213, the control part 105 returns the processing to processing step S212, and when the control part 105 determines that the measurement interval T1 is elapsed, the control part 105 returns the processing to the processing step S205.

In this manner, the altimeter according to the fifth embodiment of the present invention, and particularly, the control part 105 of the altimeter having the step number measurement part 901 which detects walking is configured to control the atmospheric pressure measurement part 104 such that the atmospheric pressure measurement interval becomes shorter when the step number measurement part 901 detects that the user is walking compared to a case where the step number measurement part 901 detects that the user is not walking.

On the other hand, the altimeter according to the fifth embodiment of the present invention, and particularly, the control part 105 of the altimeter having the step number measurement part 901 which detects walking is configured to control the atmospheric pressure measurement part 104 such that the atmospheric pressure measurement interval becomes longer when the step number measurement part 901 detects that the user is not walking compared to a case where the step number measurement part 901 detects that the user is walking.

Due to such a constitution, the altimeter of the fifth embodiment can perform necessary altitude measurement while realizing power saving corresponding to a use environment of the altimeter whether a user is walking or not. Further, there is low possibility that the altitude changes when the user is in a stop state and hence, it is possible to realize power saving without inducing the deterioration of the accuracy of measurement which may be caused by prolongation of measurement interval. On the other hand, there is high possibility that the altitude changes when the user is in a walking state and hence, it is possible to maintain the high measurement accuracy by shortening the measurement interval.

Although the respective embodiments have been explained by taking the example where the altimeter constitutes an independent single unit, the altimeter may be constituted in various modes such as a mode where the altimeter is incorporated into a portable device such as a wrist watch or a mobile phone.

According to the present application, the altimeter can be used as an independent single unit or can be used in various modes where the altimeter is an altimeter which is incorporated into a portable device such as a wrist watch.

What is claimed is:

1. An altimeter comprising:
an atmospheric pressure measurement means which measures an atmospheric pressure; and
a control means which controls an atmospheric pressure measurement interval used by the atmospheric pressure measurement means to an interval corresponding to a use environment, and also calculates an altitude based on the atmospheric pressure measured by the atmospheric pressure measurement means.

2. An altimeter according to claim 1, further comprising:
a photoelectric conversion means which generates power for driving an electric constitutional element corresponding a received light quantity; and
a generated power measurement means which measures a generated power quantity of the photoelectric conversion means, wherein
the control means controls the atmospheric pressure measurement interval used by the atmospheric pressure measurement means to an interval corresponding to the generated power quantity of the photoelectric conversion means, and also calculates the altitude based on the atmospheric pressure measured by the atmospheric pressure measurement means.

3. An altimeter according to claim 2, wherein the control means controls the atmospheric pressure measurement means such that the atmospheric pressure measurement interval becomes shorter when the generated power quantity of the photoelectric conversion means is a predetermined value or more compared to a case where the generated power quantity of the photoelectric conversion means is less than the predetermined value.

4. An altimeter according to claim 2, wherein the control means controls the atmospheric pressure measurement means such that the atmospheric pressure measurement interval becomes longer when the generated power quantity of the photoelectric conversion means is less than a predetermined value compared to a case where the generated power quantity of the photoelectric conversion means is the predetermined value or more.

5. An altimeter according to claim 3, wherein the control means controls the atmospheric pressure measurement means such that the atmospheric pressure measurement interval becomes longer when the generated power quantity of the photoelectric conversion means is less than a predetermined value compared to a case where the generated power quantity of the photoelectric conversion means is the predetermined value or more.

6. An altimeter according to claim 3, further comprising:
a secondary cell which stores generated power of the photoelectric conversion means and supplies drive power to the electric constitutional element; and
a voltage measurement means which measures a voltage of the secondary cell, wherein
the control means controls the atmospheric pressure measurement means such that the atmospheric pressure measurement interval becomes shorter when the generated power quantity of the photoelectric conversion means is a predetermined value or more and the voltage of the secondary cell is a predetermined value or more.

7. An altimeter according to claim 1, wherein the control means controls the atmospheric pressure measurement means such that the atmospheric pressure measurement interval becomes shorter when a change quantity per unit time of the atmospheric pressure measured by the atmospheric pressure measurement means or of an altitude calculated based on the atmospheric pressure measured by the atmospheric pressure measurement means is a predetermined value or more compared to a case where the change quantity per unit time of the atmospheric pressure measured by the atmospheric pressure measurement means or of the altitude calculated based on the atmospheric pressure measured by the atmospheric pressure measurement means is less than the predetermined value.

8. An altimeter according to claim 1, wherein the control means controls the atmospheric pressure measurement means such that the atmospheric pressure measurement interval becomes longer when a change quantity per unit time of the atmospheric pressure measured by the atmospheric pressure measurement means or of an altitude calculated based on the atmospheric pressure measured by the atmospheric pressure measurement means is less than a predetermined value compared to a case where the change quantity per unit time of the atmospheric pressure measured by the atmospheric pressure measurement means or of the altitude calculated based on the atmospheric pressure measured by the atmospheric pressure measurement means is the predetermined value or more.

9. An altimeter according to claim 7, wherein the control means controls the atmospheric pressure measurement means such that the atmospheric pressure measurement interval becomes longer when a change quantity per unit time of the atmospheric pressure measured by the atmospheric pressure measurement means or of an altitude calculated based on the atmospheric pressure measured by the atmospheric pressure measurement means is less than a predetermined value compared to a case where the change quantity per unit time of the atmospheric pressure measured by the atmospheric pressure measurement means or of the altitude calculated based on the atmospheric pressure measured by the atmospheric pressure measurement means is the predetermined value or more.

10. An altimeter according to claim 1, wherein the control means controls the atmospheric pressure measurement means such that the atmospheric pressure measurement interval becomes shorter when the atmospheric pressure measured by the atmospheric pressure measurement means is less than a predetermined value compared to a case where the atmospheric pressure measured by the atmospheric pressure measurement means is the predetermined value or more.

11. An altimeter according to claim 1, wherein the control means controls the atmospheric pressure measurement means such that the atmospheric pressure measurement interval becomes longer when the atmospheric pressure measured by the atmospheric pressure measurement means is a predetermined value or more compared to a case where the atmospheric pressure measured by the atmospheric pressure measurement means is less than the predetermined value.

12. An altimeter according to claim 10, wherein the control means controls the atmospheric pressure measurement means such that the atmospheric pressure measurement interval becomes longer when the atmospheric pressure measured by the atmospheric pressure measurement means is a predetermined value or more compared to a case where the atmospheric pressure measured by the atmospheric pressure measurement means is less than the predetermined value.

13. An altimeter according to claim 1, further comprising a walking detection means which detects walking, wherein
the control means controls the atmospheric pressure measurement means such that the atmospheric pressure measurement interval becomes shorter when the walking detection means detects that a user is in the midst of walking compared to a case where the walking detection means detects that a user is not in the midst of walking.

14. An altimeter according to claim 1, further comprising the walking detection means which detects walking, wherein
the control means controls the atmospheric pressure measurement means such that the atmospheric pressure measurement interval becomes longer when the walking detection means detects that a user is not in the midst of walking compared to a case where the walking detection means detects that a user is in the midst of walking.

15. An altimeter according to claim 13, further comprising the walking detection means which detects walking, wherein
the control means controls the atmospheric pressure measurement means such that the atmospheric pressure measurement interval becomes longer when the walking detection means detects that a user is not in the midst of walking compared to a case where the walking detection means detects that a user is in the midst of walking.
